(19) United States
(12) Patent Application Publication
(10) Pub. No.: US 2025/0217661 A1
(43) Pub. Date: Jul. 3, 2025

(54) PROMPT ENSEMBLE METHOD AND COMPUTING DEVICE BASED ON CONTRASTIVE LEARNING FOR EFFICIENT ADAPTATION OF EMBODIED AGENT, AND RECORDING MEDIUM THEREOF

(71) Applicant: Research & Business Foundation Sungkyunkwan University, Suwon-si (KR)

(72) Inventors: Honguk WOO, Suwon-si (KR); Wonje CHOI, Suwon-si (KR); Wookyung KIM, Suwon-si (KR); Seunghyun KIM, Suwon-si (KR)

(73) Assignee: Research & Business Foundation Sungkyunkwan University, Suwon-si (KR)

(21) Appl. No.: 18/999,551

(22) Filed: Dec. 23, 2024

(30) Foreign Application Priority Data
Dec. 27, 2023 (KR) 10-2023-0193642

(51) Int. Cl. G06N 3/092; G06V 10/774; G06V 20/70

(52) U.S. Cl. CPC G06N 3/092; G06V 10/774; G06V 20/70

(57) ABSTRACT

Provided is a prompt ensemble method based on contrastive learning, which includes: a first step of generating a prompt for each domain factor given as an input while an encoder is optimized through prompt based contrastive learning offline; and a second step of predicting a task specific state representation for an unseen domain by giving an output of the encoder to which each prompt generated in the first step is reflected as an input of an attention module online, in which the online is an environment in which an agent may learn a policy for a task through an interaction with an environment, and the offline is an environment in which the interaction with the environment is limited, and there is only pre-created data, and the domain factor as an attribute which causes a domain change in the environment is a minimum unit constituting the domain.

### CROSS-REFERENCE TO RELATED APPLICATION

This application claims the benefit of and priority to Korean Patent Application No. 10-2023-0193642, filed on Dec. 27, 2023, the entire disclosure(s) of which is hereby incorporated herein by reference in its entirety.

### BACKGROUND

### Field

The present disclosure a prompt ensemble method and a computing device based on contrastive learning, which enable an agent to be adapted to a zero-shot even in a new domain, and a recording medium thereof.

### Description of Related Art

In a study on vision-based reinforcement learning (hereinafter referred to as RL), a decoupled structure which separately trains a visual encoder and uses the visual encoder for policy learning later gains a popularity with the development of unsupervised learning and a large-scale pretrained model for a computer vision. Such decoupling shows high efficiency in a low data system with a lack of reward signals compared to end-to-end RL.

In this regard, various studies are introduced, which adopt the decoupling structure in an agent (e.g., a delivery robot) (embedded agent) which interacts with an environment, and in particular, a pre-trained vision model (e.g., ResNet) or a vision language model (e.g., CLIP) is utilized for visual state representation encoders.

However, it is not easy to achieve zero shot adaptation to the visual area change of the environment through the high variety and abnormalities encapsulated in the agent. In order to ensure a zero shot function of the agent, few methods of optimizing the popular pre-trained model are developed.

The agent has a variety of environments and physical properties, such as self-centered camera positions, strides, and lighting, which is a domain element that creates important changes in the perception and observation of agents. In a target environment where the setting for the domain element is not corrected, the RL policy, which depends on the pre-learned visual encoder, remains vulnerable to the domain change.

FIG. 1 shows an example of a self-centered visual area change which an agent experiences due to various camera locations.

In FIG. 1, a domain is illustrated, which is changed because a camera position in a source environment of an agent (robot) and a camera position in a target environment are different. In the case of the agent, the same state can be observed differently depending on a change of physical properties such as self-centered camera position, stride, lighting, and individual style. In the present disclosure, such a property which causes a domain change in the environment is referred to as a domain factor.

As illustrated in FIG. 1, when a policy learned in a source environment is applied to a target environment, a zero-shot performance may be significantly deteriorated if the visual encoder is not minutely adjusted so as to be adapted to physical diversity (e.g., a positional change of the camera) of the agent in addition an environmental difference.

### SUMMARY

The present disclosure is contrived in response the technical background, and the present disclosure has been made in an effort to enable an agent to be adapted to a zero shot for a domain change by using prompt based learning for a pretrained model in a decoupling RL structure.

In an aspect, provided is a prompt ensemble method based on contrastive learning, which includes: a first step of generating a prompt for each domain factor given as an input while an encoder is optimized through prompt based contrastive learning offline; and a second step of predicting a task specific state representation for an unseen domain by giving an output of the encoder to which each prompt generated in the first step is reflected as an input of an attention module online, in which the online is an environment in which an agent may learn a policy for a task through an interaction with an environment, and the offline is an environment in which the interaction with the environment is limited, and there is only pre-created data, and the domain factor as an attribute which causes a domain change in the environment is a minimum unit constituting the domain.

In the first step, the encoder is trained through image data obtained in a demonstration and a training set in which a cluster is labeled to each image data, and the cluster notifies a domain factor of the image data given as an input.

The encoder is a CLIP visual language model.

In the second step, the output of the encoder includes an image embedding in which the prompt is not reflected to an unseen domain and a prompted embedding in which the prompt is reflected to the unseen domain.

In the second step, the attention module optimizes an attention weight based on the image embedding and the prompted embedding, and the attention weight is optimized by reflecting a guidance score based on a cosine similarity between the image embedding and the prompted embedding.

The guidance score gᵢ is defined as

$${g}_{i} = \frac{〈 {z}_{0} , {z}_{i} 〉}{‖ {z}_{0} ‖ ‖ {z}_{i} ‖} ,$$

where z₀ represents the image embedding and zᵢ represents the prompted embedding.

The attention weight ωᵢ is defined as

$${ω}_{i} = \frac{exp ( {u}_{i} / τ )}{{\sum }_{k} exp ( {u}_{k} / τ )} , {u}_{i} = \frac{〈 {z}_{0} , {k}_{i} 〉}{\sqrt{d}} {g}_{i} ,$$

where kᵢ represents a projection of zᵢ, d represents a dimension of z, and τ represents a Softmax temperature.

The task specific state representation z is defined as

$$Z = 𝒢 ( {z}_{0} , z ) = {z}_{0} + {\sum }_{i = 1}^{n} {ω}_{i} {z}_{i} .$$

The present disclosure also discloses a computing device for a prompt ensemble method based on contrastive learning and a recording medium having the prompt ensemble method based on contrastive learning recorded therein.

It is confirmed that the present disclosure has the following effects through an experiment.

First, the RL policy learned through the present disclosure achieve a competitive zero shot performance in am embodied agent task such as a navigation task of AI2THOR, a vision-based robot operation task of Meta-World, and an autonomous driving task of CARLA.

Second, the present disclosure achieves high sample efficiency in a decoupled RL structure. For example, in the present disclosure, in order to achieve a similar performance to a target domain in a seen domain and a new unseen domain in an AI2THOR object navigation, samples less than 50.0% and 16.7% are required compared to ATC and samples less than 60% and 50% are required compared to EmbCLIP.

### BRIEF DESCRIPTION OF THE DRAWING

FIG. 1 shows an example of a self-centered visual area change which an agent experiences due to various camera locations.

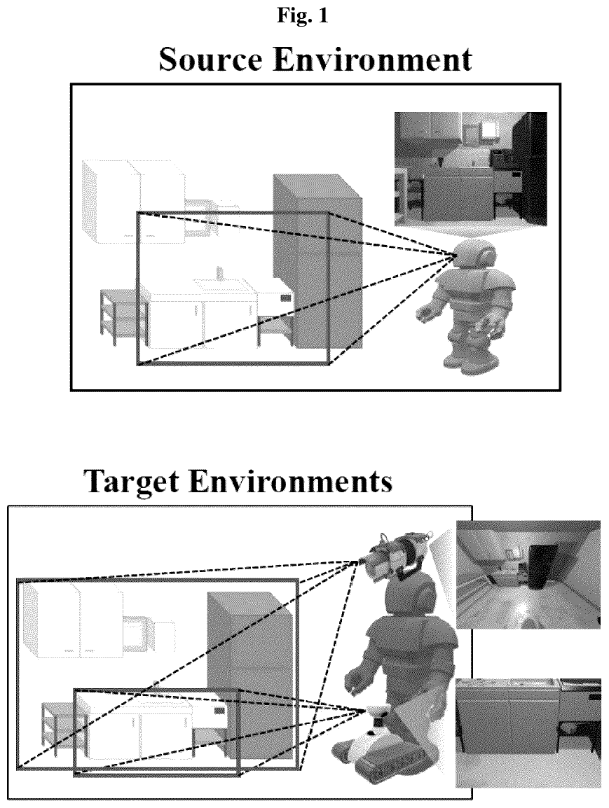

FIG. 2 is a flowchart for a contrastive learning based prompt ensemble method according to the present disclosure.

FIG. 3 is a diagram schematically illustrating a framework according to the present disclosure.

FIG. 4 is a diagram illustrating an attention based prompt ensemble.

FIG. 5 illustrates a performance from the perspective of samples used in CONPE and comparison target models for policy learning.

FIG. 6 is a diagram for describing an effect for a prompt ensemble analysis possibility.

FIG. 7 is a block diagram of a computing device of the present disclosure.

### DETAILED DESCRIPTION

Hereinafter, embodiments of the present disclosure will be described specifically with reference to drawings. However, the description of publicly-known function and construction that may make the gist of the present disclosure unnecessarily ambiguous will be omitted. Throughout the present disclosure, unless explicitly described to the contrary, the word “comprise” and variations such as “comprises” or “comprising”, will be understood to imply the inclusion of stated elements but not the exclusion of any other elements.

Further, terms including as first, second, and the like are used for describing various components, but the components are not limited by the terms. The terms may be used only for distinguishing one component from the other component. For example, a first component may be named as a second component and similarly, the second component may also be named as the first component without departing from the scope of the present disclosure.

Terms used in the present disclosure are used only to describe specific embodiments, and are not intended to limit the present disclosure. A singular form includes a plural form if there is no clearly opposite meaning in the context. In the present disclosure, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not particularly contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

The present disclosure relates to an RL policy adaptation technology that enables an agent to be adapted to a zero shot for a domain change by using prompt based learning for a pretrained model in a decoupled RL structure. In the present disclosure, the policy is an representation in performing a task given to the agent.

To this end, the present disclosure discloses a new contrastive prompt ensemble framework which uses a CLIP vision language model as a visual encoder, and facilitates active adjustment of visual state representations for the domain change through a contrastive learned visual prompt ensemble.

In other words, in the present disclosure, a CLIP visual language model is trained based on a prompt through expert demonstration data to generate a prompt for a domain factor given as an input, and an ensemble module is trained with the generated prompt to predict an optimal representation based on the prompt even for a new domain, which enables the agent to be adapted to the zero shot.

In the present disclosure, the ensemble uses an attention-based state composition for various visual embeddings of the same input observation. Here, each embedding corresponds to a state representation individually triggered by a specific domain factor.

In the present disclosure, a cosine similarity between the input observation and each prompted embedding is used for effectively calculating an attention weight.

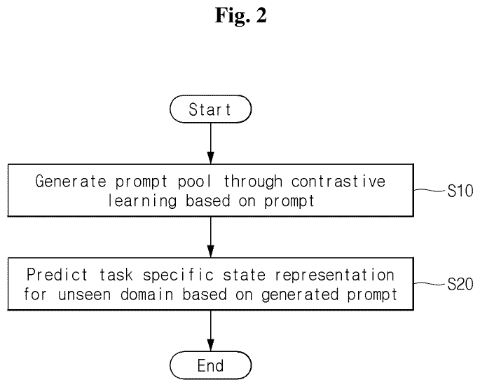

The contrastive learning based prompt ensemble method according to the present disclosure includes a first step (S10) of generating a prompt for each domain factor given as an input while an encoder is optimized through prompt based contrastive learning offline as illustrated in FIG. 2, and a second step (S20) of predicting a task specific state representation for a new domain by giving an output of the encoder to which each prompt generated in the first step is reflected as an input of an attention module online, and the online is an environment in which the agent may learn a policy for a task through an interaction with the environment and the off line represents a situation in which the interaction with the environment is limited and there is only pre-created data.

Each of the first and second steps of the contrastive learning based prompt ensemble method of the present disclosure become further embodied through the following description.

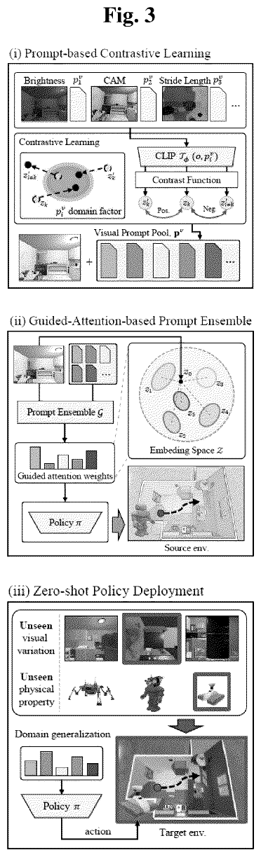

FIG. 3 is a diagram schematically illustrating a framework according to the present disclosure.

The present disclosure is constructed to generally include (i) a process (hereinafter, referred to as a first process) based on a prompt using a CLIP visual encoder generating a prompt pool, and (ii) a process (hereinafter, referred to as a second process) of learning an ensemble module which predicts a representation of an agent for a new domain based on the acquired prompt.

In the present disclosure, the CLIP visual encoder to generate a prompt for each domain factor while being optimized through contrastive learning based on the prompt offline, and the attention module is learned online based on the attention-based prompt ensemble to predict an optimal representation by reflecting the acquired prompt to a new domain.

Here, the online and the offline are classifications according to there is the environment which is enabled to interact with the environment of the agent. Here, the online means is an environment in which the agent may learn the policy for the task through the interaction with the environment, and the offline means an environment in which the interaction with the environment is limited, and there is only pre-created data.

In the first process, the CLIP visual encoder is optimized by using various visual prompts contrastively learned through expert demonstration for various domain factors, and through this, process, a visual prompt pool is created. Then, the prompt the prompt is used for training the attention-based ensemble jointly with the environment.

In the second process, the attention module uses a cosine similarity of embedding in order to increase learning efficiency and an analysis ability of an attention weight. Since the attention module and the policy are learned commonly for a specific task, a state representation is normalized over various domains, and optimized to task learning.

Hereinafter, each component constituting the present disclosure will be described in Detail as Follows.

### [S10: Prompt Based Contrastive Learning]

The prompt based contrastive learning is used for optimizing the CLIP visual encoder. In the present disclosure, the prompt of the CLIP visual encoder is learned through prompt based representation learning based on expert demonstration data for various domain factors.

The prompt of the CLIP visual encoder is learned through image data obtained in expert demonstration and a training set constructed in which a cluster is constructed in a labeled form in the image data, and the cluster is a value representing a domain factor of image data given as an input. The CLIP visual encoder learns a prompt corresponding to the cluster, i.e., the domain factor through the input training dataset.

Through the contrastive learning, the CLIP visual encoder learns a prompt robust to the domain factor, and one prompt is created for each domain factor. That is, when n domain factors are given to the CLIP visual encoder, the CLIP visual encoder creates the numerically same n prompts through learning.

Consequently, through the contrastive learning, the CLIP visual encoder creates a prompt pool having a size corresponding to the number of domain factors (clusters) given as the input.

The process of contrastively learning the prompt of the CLIP visual encoder is described in more detail as follows.

In order to construct domain-invariant representations for self-centered recognition data, several contrast tasks for visual prompt learning may be adopted, which may be learned through expert demonstration (or demo), and the prompt may be defined as in Equation 1.

$${p}^{v} = [ {e}_{1}^{v} , {e}_{2}^{v} , … , {e}_{u}^{v} ] , {e}_{i}^{v} ∈ {ℝ}^{d} \qquad [ Equation 1 ]$$

Where eᵢ^{v} represents a continuous learnable vector having an image patch embedding dimension d (e.g., 768 in the case of the CLIP visual encoder), and u represents a length of a visual prompt.

It is assumed that a pretrained model (CLIP visual encoder) T_{∅} parameterized to ∅ maps an observation value o∈Ω to an embedding space Z.

In order to distinguish whether an observation pair is positive, observation pair placement β_{P}={(oᵢ, oᵢ′)}i≤m having a size of m includes one positive pair {(oₖ, oₖ′)|P(oₖ, oₖ′)=1} with respect to some k≤m by using a contrast function (P: Ω×Ω→{0, 1}).

Then, a visual prompt P^{v} is learned through the contrastive learning to optimize T_{∅}. Here, a contrast loss function is defined as in Equation 2.

$${ℒ}_{CON} ( {p}^{v} , {ℬ}_{P} ) = - log ( \frac{S ( {𝒯}_{ϕ} ( {o}_{k} , {𝒯}_{ϕ} ( {o}_{k}^{′} , {p}^{v} ) )}{{\sum }_{i \neq k} S ( {𝒯}_{ϕ} ( {o}_{i} , {p}^{v} ) , {𝒯}_{ϕ} ( {o}_{i}^{′} , {p}^{v} ) )} ) , \qquad [ Equation 2 ]$$

$$S ( x , y ) = \frac{1}{λ} exp ( \frac{〈 x , y 〉}{‖ x ‖ ‖ y ‖} )$$

In the case of a latent vector x, y∈Z, a similarity in an embedding space Z is calculated as S(x, y). Here, λ represents a hyper parameter. The prompt based contrast learning is performed with respect to n different domain factors to obtain a visual prompt pool having n visual prompts as in Equation 3.

$${p}^{v} = [ {p}_{1}^{v} , {p}_{2}^{v} , … , {p}_{n}^{v} ] \qquad [ Equation 3 ]$$

Through this process, each visual prompt encapsulates a specific domain-invariant knowledge.

### [S20: Attention Based Prompt Ensemble]

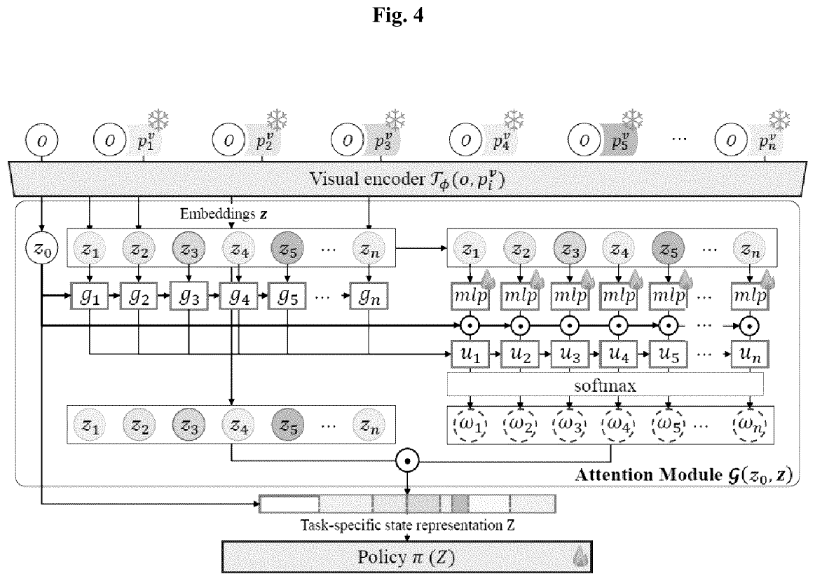

The present disclosure proposes an attention based prompt ensemble structure illustrated in FIG. 4 in order to integrate individual prompt embeddings of multiple visual prompts into the task specific state representation. Here, an attention weight for the embedding is actively calculated in an attention module [symbol] with respect to each observation.

When an observation (and the learned visual prompt pool P^{v} are given, an image embedding z₀= [symbol] (o) and a prompted embedding z=[z₁= [symbol] (o, p₁^{v}), . . . , zₙ] are calculated. In the present disclosure, the observation refers to a domain which is not used when contrastively learning the prompt of the CLIP visual encoder.

Here, the image embedding z₀ is an output of a CLIP visual encoder [symbol] to which the prompt is not reflected, and the prompted embedding zᵢ is an output of the CLIP visual encoder [symbol] in which the prompt is reflected to each observation.

Then, zₒ and Z are input into the attention module, and here, an attention weight ωᵢ for each prompted embedding zᵢ is optimized.

Here, since immediately calculating the attention weight by using zₒ and z may cause a localization which is impossible to analyze, a guidance score is introduced which is based on a cosine similarity between the input image and a visual prompted image embedding [symbol] . Here, the guidance score is defined as in Equation 4.

$${g}_{i} = \frac{〈 {z}_{0} , {z}_{i} 〉}{‖ {z}_{0} ‖ ‖ {z}_{i} ‖} \qquad [ Equation 4 ]$$

By considering that as the guidance score becomes larger, the guidance score has a stronger association with the domain factor related to the prompted embedding zᵢ, the guidance score is introduced to adjust the attention weight for a purpose of enhancing learning efficiency and increasing an analysis possibility.

When the guidance score is considered, the attention weight ωᵢ is calculated as in Equation 5.

$${ω}_{i} = \frac{exp ( {u}_{i} / τ )}{{\sum }_{k} exp ( {u}_{k} / τ )} , {u}_{i} = \frac{〈 {z}_{0} , {k}_{i} 〉}{\sqrt{d}} {g}_{i} \qquad [ Equation 5 ]$$

Where kᵢ represents a projection of zᵢ, d represents a dimension of z, and τ represents a Softmax temperature.

Next, a state embedding Z (or policy) may be obtained as in Equation 6.

$$Z = 𝒢 ( {z}_{0} , z ) = {z}_{0} + {\sum }_{i = 1}^{n} {ω}_{i} {z}_{i} \qquad [ Equation 6 ]$$

Hereinafter, an effect of the present disclosure described above will be described.

### Experiment Setting

In order to find out the effect, an inventor uses task specific AI2THOR, Metaworld, and CARLA environments of the agent having a dynamic domain change. Such an environment enables various domain factors such as camera setting, stride, rotation, gravity, lighting, wind speed, etc. In the prompt based contrastive learning (first process), a small-scale expert demonstration data set (i.e., 10 episodes per domain factor) for each domain factor is used. In the policy learning (second process), several source domains which are randomly generated are used through combination variation of seen domain factors (e.g., four source domains).

For performance comparison, the following models are compared in an experiment. LUSR as a reconstruction based domain adaptation method of RL uses a variational autoencoder structure for a strong representation. CURL and ACT use the contrastive learning in an RL framework for high sample efficiency and normalization for a visual area. ACO utilizes augmentation-driven and behavior-driven contrastive learnings in a context of RL. EmbCLIP is a state-of-the-art implementation AI model which utilizes the CLIP visual encoder pretrained for the visual state representation.

In this experiment, CONPE which is a frame according to the present disclosure is implemented by using a CLIP model jointly with ViT-B/32 similar to VPT and CoOp. In the prompt based contrastive learning, various contrastive learning schemes including augmentation-driven and behavior-driven contrastive learnings in which a prompt length is set to 8 are adopted. In the policy learning, online learning (e.g., PPO) for AI2THOR and imitation learning (e.g., DAGGER) for egocentric-Metaworld and CARLA are utilized.

### Effects

### 2.1 Zero-Shot Performance

Table 1 show comparisons of zero-shot performances and of CONPE and performances of comparison target models for a source domain, a seen domain, and an unseen domain.

TABLE 1
(a) Zero-shot Performance in AI2THOR with Object and Point Goal Navigation Tasks

| | ObjectNav. | | | PointNav. | | |
|---|---|---|---|---|---|---|
| Method | Source | Seen Target | Unseen Target | Source | Seen Target | Unacen Target |
| LUSR | 53.3 ± 1.1 | 21.3 ± 1.9 | 15.1 ± 1.8 | 85.6 ± 4.6 | 71.8 ± 3.8 | 62.4 ± 5.8 |
| CURL | 51.3 ± 1.0 | 8.0 ± 0.1 | 6.9 ± 1.3 | 70.8 ± 7.4 | 55.2 ± 2.7 | 54.8 ± 3.0 |
| ATC | 82.2 ± 9.7 | 72.3 ± 3.3 | 51.3 ± 8.6 | 95.0 ± 3.3 | 89.1 ± 1.9 | 81.9 ± 3.6 |
| ACO | 55.0 ± 23.8 | 39.6 ± 21.5 | 35.8 ± 5.8 | 91.1 ± 6.3 | 73.4 ± 2.0 | 67.5 ± 2.8 |
| EmbCLIP | 89.3 ± 3.0 | 77.6 ± 1.3 | 59.0 ± 6.4 | 95.3 ± 4.6 | 84.5 ± 1.9 | 77.4 ± 1.4 |
| CONPE | 96.3 ± 1.0 | 83.3 ± 0.3 | 79.7 ± 6.4 | 97.8 ± 1.0 | 89.7 ± 1.6 | 84.3 ± 2.0 |

(b) Zero-shot Performance in egocentric-Metaworld with Reach and Reach-wall Tasks

| | Reach | | | Reach-Wall | | |
|---|---|---|---|---|---|---|
| Method | Source | Seen Target | Unseen Target | Source | Seen Target | Unseen Target |
| LUSR | 100.0 ± 0.0 | 46.0 ± 15.1 | 44.7 ± 2.3 | 50.0 ± 10.0 | 33.3 ± 6.1 | 30.7 ± 6.4 |
| CURL | 100.0 ± 0.0 | 53.3 ± 5.0 | 46.7 ± 3.1 | 43.3 ± 15.3 | 2.0 ± 0.0 | 0.7 ± 1.2 |
| ATC | 100.0 ± 0.0 | 71.3 ± 8.1 | 72.0 ± 2.0 | 66.7 ± 5.8 | 5.3 ± 1.2 | 4.0 ± 0.0 |
| ACO | 100.0 ± 0.0 | 52.0 ± 2.0 | 44.0 ± 3.5 | 63.3 ± 15.3 | 8.7 ± 2.3 | 4.7 ± 1.2 |
| EmbCLIP | 100.0 ± 0.0 | 64.7 ± 6.1 | 66.7 ± 4.2 | 100.0 ± 0.0 | 58.0 ± 7.2 | 49.3 ± 5.0 |
| CONPE | 100.0 ± 0.0 | 88.7 ± 3.1 | 86.7 ± 3.1 | 100.0 ± 0.0 | 75.3 ± 3.1 | 67.3 ± 2.3 |

(c) Zero-shot Performance in CARLA with Different Maps

| | Map 1 | | | Map 2 | | |
|---|---|---|---|---|---|---|
| Method | Source | Seen Target | Unseen Target | Source | Seen Target | Unseen Target |
| LUSR | 2141.9 | 635.1 ± 606.2 | 1073.9 ± 212.6 | 2279.6 | 1173.7 ± 914.3 | 2159.4 ± 146.5 |
| CURL | 945.4 | 864.2 ± 638.0 | 1256.0 ± 61.6 | 1050.1 | 1089.9 ± 824.0 | 2190.3 ± 10.2 |
| ATC | 2280.5 | 1684.4 ± 368.2 | 1073.7 ± 618.8 | 2272.2 | 2253.9 ± 218.7 | 2200.1 ± 307.8 |
| ACO | 2265.8 | 1545.6 ± 596.1 | 1330.0 ± 144.5 | 2270.6 | 2360.9 ± 88.0 | 2415.5 ± 53.0 |
| EmbCLIP | 2235.7 | 1732.2 ± 588.6 | 1415.1 ± 669.9 | 2262.7 | 2139.1 ± 655.9 | 2401.3 ± 12.3 |
| CONPE | 2237.5 | 1738.0 ± 163.5 | 1933.4 ± 29.7 | 2277.2 | 2422.5 ± 79.6 | 2512.9 ± 15.7 |

In an experiment, CONPE was compared with three other models, and an average performance thereof (e.g., task success rates in AI2THOR and Metaworld, and a compensation sum in CARLA) was seen.

As shown in Table 1(a), CONPE showed a better performance than AI2THOR. In particular, a success rate of a seen target domain was 5.2 to 5.7% and a success rate of an unseen target domain was 6.9 to 20.7%, which surpassed EmbCLIP which is a most competitive baseline.

In the case of Metaworld, as shown in Table 1(b), CONPE showed higher performances than EmbCLIP by 17.3 to 24.0% and 18.0 to 20.0%, respectively in both the seen target domain and the unseen target domain.

For autonomous driving of CARLA, external environmental elements such as a weather condition and a time zone were set to a domain factor which may affect an operation task.

In Table 1(c), CONPE surpassed a reference by consistently maintaining a competitive zero-shot performance under all conditions.

A reconstruction-based representation model reduces some task-specified information in an observation, so LUSR shows a relatively low success rate. EmbCLIP shows a most prominent performance among the comparison target models, but does not compare the zero-shot performance for the target domain with CONPE.

In contrast, CONPE effectively estimated domain movement related to each domain factor by using a guided attention weight, and showed a strongest performance in both the seen target domain and the unseen domain.

### 2.2 Sample Efficiency

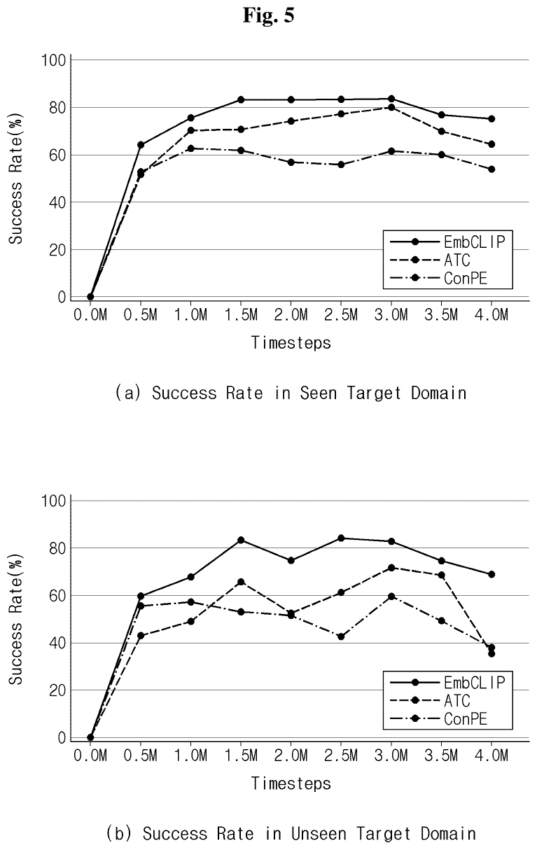

FIG. 5 illustrates a performance from the perspective of samples used in CONPE and comparison target models for policy learning.

When compared with EmbCLIP which is the most competitive model, CONPE required a smaller time step (online samples) than 60% with respect to the seen target domain, and required a time step smaller than 50% for the unseen target domain in order to obtain a competitive success rate.

### 2.3 Prompt Ensemble Analysis Possibility

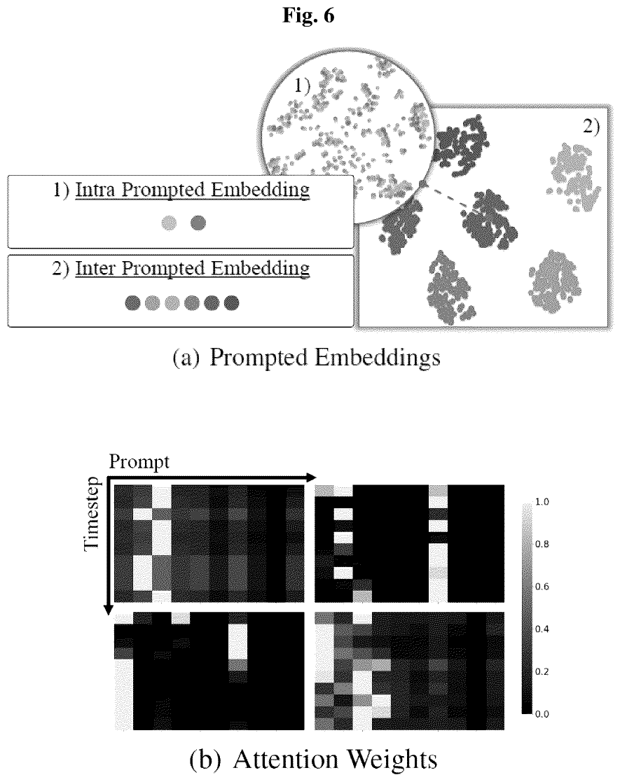

FIG. 6A illustrates visualization of the prompt embedding by using the prompt pool obtained through CONPE. In the case of an intra prompt embedding, as each pair, observation pairs were used, which were created by various domains in the domain factor. Since the visual prompt is learned through the prompt based contrastive learning, it were able to be observed that embeddings form a pair to form a domain-invariant knowledge.

The visual prompts may be exchanged and obtained between the prompted embeddings, and with respect to each prompt, the inventor used observations which are changed in the domain factor suitable for the prompt. This refers to a case where the embedding forms the cluster based on the visual prompt.

FIG. 6B illustrates an example of an attention weight matrix of CONPE for four different domains. An x axis indicates the visual prompt and a y axis indicates the time step. This shows a consistency of an attention weight for the prompt throughout the time steps of the same domain.

### 2.4 Prompt Ensemble Using Pretrained Policy

Joint learning for the policy and the attention module [symbol] is presented previously, but here, a method which makes the policy to be adapted to the domain change by updating [symbol] for a pretrained policy π is also presented. In this case, in order to concentrate on a task related feature in observing the pretrained policy π, a prompted embedding \tilde{z}₀ including the task related feature is integrated into an attention based ensemble, i.e., π( [symbol] (\tilde{z}₀, z)), where \tilde{z}₀=τ_{ϕ}(o, pₚₒₗ^{v}) by adding a policy prompt pₚₒₗ^{v}.

Table 2 shows a zero-shot performance for a scenario providing the pretrained policy. The inventor evaluated two different cases. A first case (aligned) is a case where prompt based contrastive learning is performed for data output from the same task of the pretrained policy, and a second case (not aligned) is an opposite case.

TABLE 2

| (a) Zero-shot Performance in AI2THOR with Visual Navigation and Room Rearrangement Tasks | | | | |
|---|---|---|---|---|
| | ObjectNav. (Aln.) | PointNav. (Not Aln.) | ImageNav. (Not Aln.) | RoomR. (Not Aln.) |

| Method | Source | Target | Source | Target | Souce | Target | Scoure | Target |
|---|---|---|---|---|---|---|---|---|
| Pretrained | 87.5 ± 17.2 | 65.8 ± 19.1 | 95.3 ± 4.6 | 80.9 ± 1.6 | 77.2 ± 3.3 | 56.2 ± 2.2 | 87.3 ± 3.1 | 75.2 ± 13.2 |
| CONPE | 88.4 ± 1.7 | 72.8 ± 3.1 | 98.9 ± 1.0 | 84.4 ± 1.0 | 79.2 ± 1.4 | 61.6 ± 1.1 | 93.3 ± 1.2 | 82.2 ± 14.4 |

(b) Zero-shot Performance in egocentric-Metaworld with 4 Different Robot Manipulation Tasks

| | Reach (Aln.) | | Reach-Wall (Not Aln.) | | Button-Press (Not Aln.) | | Door-Open (Not Aln.) | |
|---|---|---|---|---|---|---|---|---|
| Method | Source | Target | Source | Target | Source | Target | Source | Target |
| Pretrained | 100.0 ± 0.0 | 65.7 ± 6.4 | 100.0 ± 0.0 | 58.0 ± 5.8 | 100.0 ± 0.0 | 16.8 ± 2.3 | 100.0 ± 0.0 | 35.6 ± 6.2 |
| CONPE | 100.0 ± 0.0 | 74.7 ± 5.0 | 100.0 ± 0.0 | 75.7 ± 9.0 | 100.0 ± 0.0 | 73.7 ± 8.3 | 100.0 ± 0.0 | 93.2 ± 1.1 |

In AI2THOR, data through an object goal navigation task was used for the prompt based contrastive learning, while each pretrained policy was individually learned through one of object goal navigation, point goal navigation, image goal navigation, and room rearrangement. Similarly, in Metaworld, data through a reach task was used for the prompt based contrastive learning, while each pretrained policy was individually learned through one of tasks including reach, reach-wall, button-press, and door-open.

In Table 2(a), CONPE enhanced the zero-shot performance of the pretrained policy by 3.5 to 7.0% for the unseen target domain in AI2THOR. Only 400 K samples corresponding to 10% of all samples used for the policy learning were required for the adaptation of the prompt ensemble. In Table 2(b), CONPE significantly enhanced the zero-shot performance of the pretrained policy by approximately 9.0 to 57.6% in Metaworld.

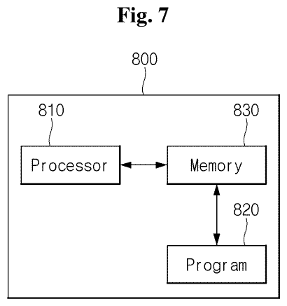

Hereinafter, a computing device that implements the above-described contrastive learning based prompt ensemble will be described with reference to FIG. 7. FIG. 7 as a block diagram illustrating a schematic construction of the computing device illustrates reconstruction of a series of components described above from the viewpoint of a hardware construction. Accordingly, here, in order to the duplication of the description, only an outline will be summarized based on a function and an operation of each component.

The computing device 800 includes a memory 830 storing a program 820 coded so as for a computer to read the above-described contrastive learning based prompt ensemble method, and a processor 810 executing the program.

The contrastive learning based prompt ensemble method includes a first step of generating a prompt for each domain factor given as an input while an encoder is optimized through prompt based contrastive learning offline as illustrated in FIG. 2, and a second step of predicting a task specific state representation for a new domain by giving an output of the encoder to which each prompt generated in the first step is reflected as an input of an attention module online as described above, and the online is an environment in which the agent may learn a policy for a task through an interaction with the environment, the off line represents an environment in which the interaction with the environment is limited and there is only pre-created data, and the domain factor as an attribute which causes the domain change in the environment represents a minimum unit constituting the domain.

Meanwhile, it is possible to implement the contrastive learning based prompt ensemble method according to the present disclosure described above with a code a computer-readable code in a computer readable recording medium. The computer readable recording medium includes all kinds of recording devices storing data which may be deciphered by a computer system.

Examples of the computer readable recording medium include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method. In addition, functional programs, codes, and code segments for implementing the present disclosure may be easily inferred by programmers in technical field to which the present disclosure pertains.

Hereinabove, the present disclosure has been described above based on various embodiments thereof. It is understood to those skilled in the art that the present disclosure may be implemented as a modified form without departing from an essential characteristic of the present disclosure. Therefore, the disclosed embodiments should be considered in an illustrative viewpoint rather than a restrictive viewpoint. The scope of the present disclosure is defined by the appended claims rather than by the foregoing description, and all differences within the scope of equivalents thereof should be construed as being included in the present disclosure.

1. A prompt ensemble method based on contrastive learning, comprising:
a first step of generating a prompt for each domain factor given as an input while an encoder is optimized through prompt based contrastive learning offline; and
a second step of predicting a task specific state representation for an unseen domain by giving an output of the encoder to which each prompt generated in the first step is reflected as an input of an attention module online,
wherein the online is an environment in which an agent may learn a policy for a task through an interaction with an environment, and the offline is an environment in which the interaction with the environment is limited, and there is only pre-created data, and
the domain factor as an attribute which causes a domain change in the environment is a minimum unit constituting the domain.

2. The prompt ensemble method based on contrastive learning of claim 1, wherein in the first step, the encoder is trained through image data obtained in a demonstration and a training set in which a cluster is labeled to each image data, and
the cluster notifies a domain factor of the image data given as an input.

3. The prompt ensemble method based on contrastive learning of claim 1, wherein the encoder is a CLIP visual language model.

4. The prompt ensemble method based on contrastive learning of claim 1, wherein in the second step, the output of the encoder includes an image embedding in which the prompt is not reflected to an unseen domain and a prompted embedding in which the prompt is reflected to the unseen domain.

5. The prompt ensemble method based on contrastive learning of claim 4, wherein in the second step, the attention module optimizes an attention weight based on the image embedding and the prompted embedding, and
the attention weight is optimized by reflecting a guidance score based on a cosine similarity between the image embedding and the prompted embedding.

6. The prompt ensemble method based on contrastive learning of claim 5, wherein the guidance score gᵢ is defined as
$${g}_{i} = \frac{〈 {z}_{0} , {z}_{i} 〉}{‖ {z}_{0} ‖ ‖ {z}_{i} ‖} ,$$
where z₀ represents the image embedding and zᵢ represents the prompted embedding.

7. The prompt ensemble method based on contrastive learning of claim 6, wherein the attention weight ωᵢ is defined as
$${ω}_{i} = \frac{exp ( {u}_{i} / τ )}{{\sum }_{k} exp ( {u}_{k} / τ )} , {u}_{i} = \frac{〈 {z}_{0} , {k}_{i} 〉}{\sqrt{d}} {g}_{i} ,$$
where kᵢ represents a projection of represents a dimension of z, and τ represents a Softmax temperature.

8. The prompt ensemble method based on contrastive learning of claim 7, wherein the task specific state representation z is defined as
$$Z = 𝒢 ( {z}_{0} , z ) = {z}_{0} + {\sum }_{i = 1}^{n} {ω}_{i} {z}_{i} .$$

9. A recording medium having a program coded to read a prompt ensemble method based on contrastive learning disclosed in claim 1 by a computer recorded therein.

10. A computing device comprising:
a memory storing a program coded to read a prompt ensemble method based on contrastive learning by a computer; and
a processor executing the program,
wherein the prompt ensemble method based on contrastive learning includes
a first step of generating a prompt for each domain factor given as an input while an encoder is fine-tuned through prompt based contrastive learning offline, and
a second step of predicting a task specific state representation for an unseen domain by giving an output of the encoder to which each prompt generated in the first step is reflected as an input of an attention module online, and
the online is an environment in which an agent may learn a policy for a task through an interaction with an environment, and the offline is an environment in which the interaction with the environment is limited, and there is only pre-created data, and
the domain factor as an attribute which causes a domain change in the environment is a minimum unit constituting the domain.

11. The computing device of claim 10, wherein in the first step, the encoder is trained through image data obtained in a demonstration and a training set in which a cluster is labeled to each image data, and
the cluster notifies a domain factor of the image data given as an input.

12. A computing device of claim 10, wherein the encoder is a CLIP visual language model.

13. The computing device of claim 10, wherein in the second step, the output of the encoder includes an image embedding in which the prompt is not reflected to an unseen domain and a prompted embedding in which the prompt is reflected to the unseen domain.

14. The computing device of claim 13, wherein in the second step, the attention module optimizes an attention weight based on the image embedding and the prompted embedding, and
the attention weight is optimized by reflecting a guidance score based on a cosine similarity between the image embedding and the prompted embedding.

15. The computing device of claim 14, wherein the guidance score gᵢ is defined as
$${g}_{i} = \frac{〈 {z}_{0} , {z}_{i} 〉}{‖ {z}_{0} ‖ ‖ {z}_{i} ‖} ,$$
where z₀ represents the image embedding and zᵢ represents the prompted embedding.

16. The computing device of claim 15, wherein the attention weight ωᵢ is defined as
$${ω}_{i} = \frac{exp ( {u}_{i} / τ )}{{\sum }_{k} exp ( {u}_{k} / τ )} , {u}_{i} = \frac{〈 {z}_{0} , {k}_{i} 〉}{\sqrt{d}} {g}_{i} ,$$
where kᵢ represents a projection of zᵢ, d represents a dimension of z, and τ represents a Softmax temperature.

17. The computing device of claim 16, wherein the task specific state representation z is defined as
$$Z = 𝒢 ( {z}_{0} , z ) = {z}_{0} + {\sum }_{i = 1}^{n} {ω}_{i} {z}_{i} .$$
